(19) United States
(12) Patent Application Publication
(10) Pub. No.: US 2013/0311956 A1
(43) Pub. Date: Nov. 21, 2013

(54) INPUT ERROR-CORRECTION METHODS AND APPARATUSES, AND AUTOMATIC ERROR-CORRECTION METHODS, APPARATUSES AND MOBILE TERMINALS

(71) Applicant: MEDIATEK SINGAPORE PTE. LTD., Singapore (SG)

(72) Inventor: YAJUN LI, Beijing (CN)

(73) Assignee: MediaTek Singapore Pte. Ltd., Singapore (SG)

(21) Appl. No.: 13/799,690

(22) Filed: Mar. 13, 2013

(30) Foreign Application Priority Data
May 17, 2012 (CN) 201210154222.X

(51) Int. Cl. G06F 3/01

(52) U.S. Cl. CPC G06F 3/017
USPC 715/863

(57) ABSTRACT

An input error-correction method for a software keyboard is provided. The method includes: when entering an input key on the software keyboard, detecting if there is a sliding input; if there is a sliding input, obtaining a slide angle and a slide direction from the sliding input; and determining a target key to replace the input key according to the input key, the slide angle, and the slide direction for input error correction.

### CROSS REFERENCE TO RELATED APPLICATIONS

This Non-provisional application claims priority under 35 U.S.C. §119(a) on Patent Application No(s). 201210154222.x, filed in The People's Republic of China on May 17, 2012, the entire contents of which are hereby incorporated by reference.

### BACKGROUND OF THE INVENTION

1. Field of the Invention

The present invention relates to input error correction for input devices, and in particular relates to input error-correction methods and apparatuses for software keyboards, and automatic error-correction methods and apparatus for input devices and mobile terminals.

2. Description of the Related Art

When using software keyboards or physical keyboards (on mobile phones or the like), the user sometimes presses adjacent keys rather than the correct keys, because 26 letter keys and the function keys on the software keyboard or physical keyboards are usually arranged in a limited space. This causes two problems. Number one, the process for correcting incorrect input is complicated. For example, when a user wants to input “J” with a Qwerty keyboard but inadvertently press the key “M”, he needs two steps to correct this error: deleting the “M” and then carefully re-entering the “J”. Number two, it is simply difficult for some users (due to personal habitor screen size) to avoid this error. Currently, some mobile phones have dedicated applications for correcting input error, but there is no program or application which can correct input errors for all kinds of mobile phones and all kinds of user habits.

Therefore, improving the input success rate is a technical problem which needs to be solved.

### BRIEF SUMMARY OF THE INVENTION

The present invention provides an input error-correction method for a software keyboard, of the method comprising: when entering an input key on the software keyboard, detecting if there is a sliding input; if there is a sliding input, obtaining a slide angle and a slide direction from the sliding input; and determining a target key to replace the input key according to the input key, the slide angle, and the slide direction for input error correction.

The present invention also provides an input error-correction apparatus for a software keyboard, which comprising: a detection unit, for detecting if there is a sliding input when an input key on the software keyboard is entered; an obtaining unit, for obtaining a slide angle and a slide direction from the sliding input; and an error correction unit, for determining a target key to replace the input key, according to the input key, the slide angle, and the slide direction for input error correction.

The present invention also provides an input error-correction method for a software keyboard, which comprising: when entering an input key on the software keyboard, detecting if there is a sliding input; if there is a sliding input, obtaining the input position of the input key, and the slide angle from the sliding input; and determining a target key to replace the input key according to the input position and the slide angle for input error correction.

The present invention also provides an input error-correction apparatus for a software keyboard, which comprising: a detection unit, for detecting if there is a sliding input when an input key on the software keyboard is entered; an obtaining unit, for obtaining the input position of the input key, and the slide angle from the sliding input; and an error correction unit, for determining a target key to replace the input key according to the input position and the slide angle for input error correction.

The present invention also provides an automatic error-correction method for an input device, which comprising: when entering an input key on the input device, determining if it needs to be corrected; if the input key needs to be corrected, obtaining a correction item corresponding to the input key according to correction data corresponding to the input key stored in a correction database; and automatically replacing the input key with the correction item corresponding to the input key for error correction.

The present invention also provides an automatic error-correction apparatus for an input device, which comprising: a storage unit, for storing a correction database containing correction data; a determination unit, for determining, when an input key of the input device is entered, if the input key needs to be corrected; a decision unit, for obtaining a correction item corresponding to the input key according to the correction data corresponding to the input key stored in the correction database; and an error correction unit, for automatically replacing the input key with the correction item corresponding to the input key for error correction.

The present invention also provides a mobile terminal, which comprises one of the input error-correction apparatuses as described above for performing error correction for the input of a software keyboard of the mobile terminal.

The present invention also provides a mobile terminal, which comprises one of the automatic error-correction apparatuses as described above for performing automatic error correction on the input to the input device of the mobile terminal.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is schematic diagram of an input device according to an embodiment of the present invention.

FIG. 2 is a schematic diagram of an input error-correction apparatus according to an embodiment of the present invention.

FIG. 3 illustrates a slide angle according to an embodiment of the present invention.

FIG. 4 illustrates another slide angle according to another embodiment of the present invention.

FIG. 5 illustrates the boundaries between the areas of the adjacent keys based on a Qwerty keyboard according to an embodiment of the present invention.

FIG. 6 is a schematic diagram of an input error-correction apparatus according to an embodiment of the present invention.

FIG. 7 is a schematic diagram of the input error-correction apparatus according to another embodiment of the present invention.

FIG. 8 is a schematic diagram showing an input key which is divided into several small areas according to an embodiment of the present invention.

FIG. 9 shows the divided correction areas according to an embodiment of the present invention.

FIG. 10 shows the divided correction areas according to another embodiment of the present invention.

FIG. 11 is a flow chart of the input error-correction method according to an embodiment of the present invention.

FIG. 12 is a flow chart of the input error-correction method according to an embodiment of the present invention.

FIG. 13 is a flow chart of the input error-correction method according to an embodiment of the present invention.

FIG. 14 is a schematic diagram of the automatic error-correction apparatus according to an embodiment of the present invention.

FIG. 15 is a schematic diagram of the automatic error-correction apparatus according to an embodiment of the present invention.

FIG. 16 is a flow chart of the automatic error-correction method according to an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

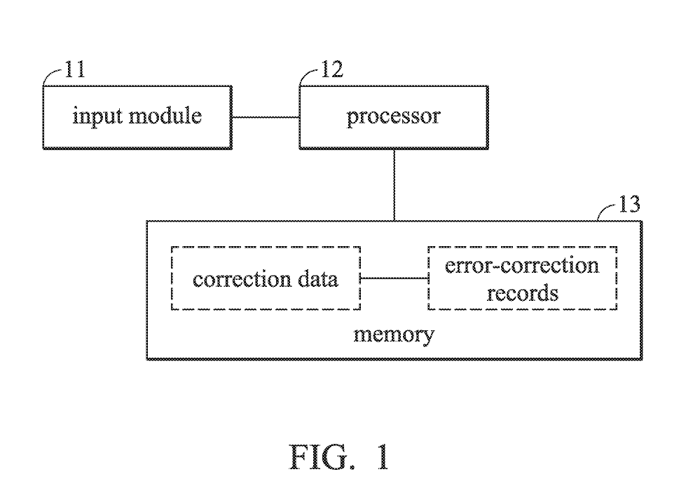

FIG. 1 is schematic diagram of an input device according to an embodiment of the present invention. Note that the input device of the present invention may be a mobile phone, a PDA, a tablet, a smart TV or the like which comprises a software keyboard. The input device may comprise an input module 11 and a processor 12. The input module 11 is used for the input of the input keys of the software keyboard. For example, in some embodiments, a user can input data by clicking (touching) the input key on the software keyboard with his finger directly (or by other means indirectly). The processor 12 coupled to the input module 11 is used for performing error correction on the input to the input module 11. In this embodiment, the processor 12 is the input error-correction apparatus of the present invention. For example, in some embodiments, the processor 12 is used to replace an incorrectly input “J” by a correct “U”. Optionally, the input device further comprises a memory 13 which is coupled to the processor 12. The memory 13 is used for storing error-correction records (for example, a record with regard to updating “J” by “U”) and correction data for correcting errors (for example, “U” is the correction data for correcting the error “J”).

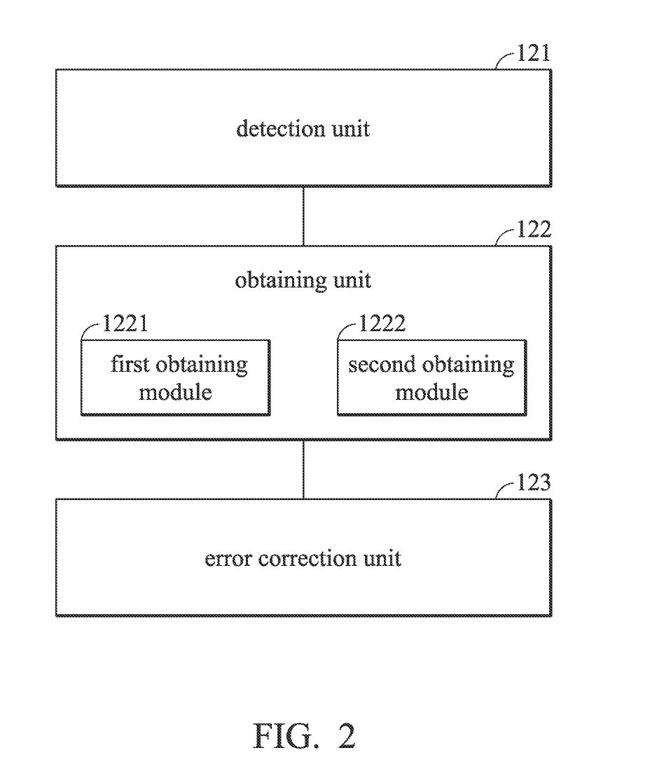

FIG. 2 is a schematic diagram of an input error-correction apparatus according to an embodiment of the present invention. In some embodiments, as shown in FIG. 2, the processor 12 comprises a detection unit 121, an obtaining unit 122 and an error correction unit 123. The detection unit 121 is used for detecting if there is a sliding input when an input key on a software keyboard is entered. For example, in some embodiments, a user may click (touch) an input key on the software keyboard so that a corresponding character of the input key is displayed, and then slide his finger or the like on the input surface of the input module 11. For example, the said sliding input may go from the left to the right, or from the lower right to the upper left; it may go in a straight line or a curve. The detection unit 121 is used for detecting if there is sliding input.

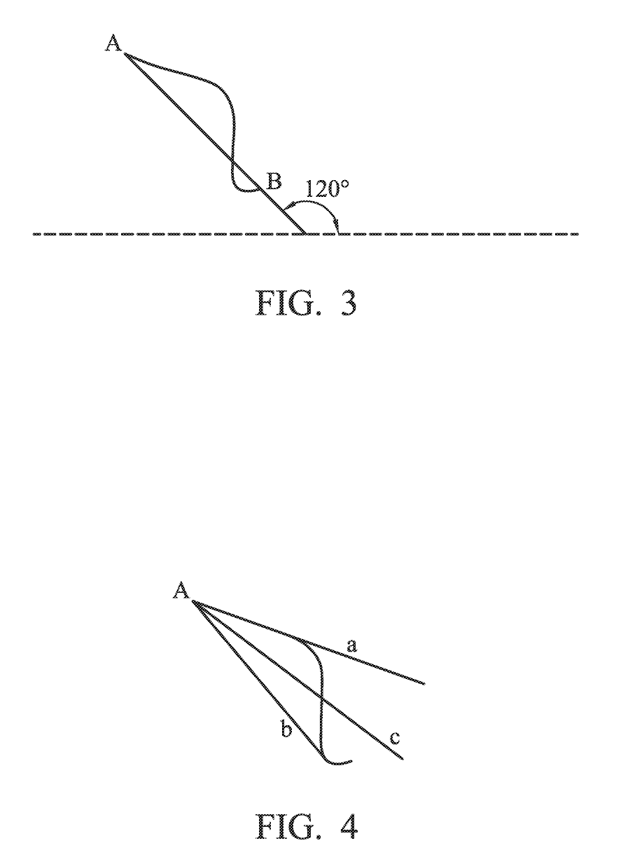

The obtaining unit 122, which is coupled to the detection unit 121, is used for obtaining a slide angle and a slide direction from the sliding input. An embodiment is shown in FIG. 3. FIG. 3 illustrates a slide angle according to an embodiment of the present invention. The curve shown in FIG. 3 is the sliding locus of the sliding input, and the slide angle is the angle of a straight line which is defined by the starting point A and the end point B of the sliding input (e.g., 120°), as shown in FIG. 3. The obtaining unit 122 comprises a first obtaining module 1221, and the first obtaining module 1221 is used for obtaining the slide angle by using the manner of FIG. 3. Another embodiment is shown in FIG. 4, which illustrates another slide angle according to another embodiment of the present invention. The curve shown in FIG. 4 is the sliding locus of the sliding input, and the slide angle is defined by the following steps: obtaining a series of rays, each defined by the starting point A of the sliding input and one of the points on the sliding locus; and obtaining an angular bisector (line c) of a most inclined ray (line a) and a least inclined ray (line b), both selected from the series of rays. The angle of the angular bisector (line c) is the slide angle in this embodiment. The obtaining unit 122 comprises a second obtaining module 1222, and the second obtaining module 1222 is used for obtaining the slide angle by using the manner described in FIG. 4. In one embodiment, the first obtaining module 1221 and the second obtaining module 1222 are different modules. In another embodiment, the first obtaining module 1221 and the second obtaining module 1222 are integrated into a common module. Note that the techniques for finding the slide angle described above are merely for illustration, and the present invention should not be limited thereto. With the techniques of FIG. 3 or FIG. 4, the obtaining unit 122 can obtain the slide angle and also the slide direction, for example, the direction AB in FIG. 3.

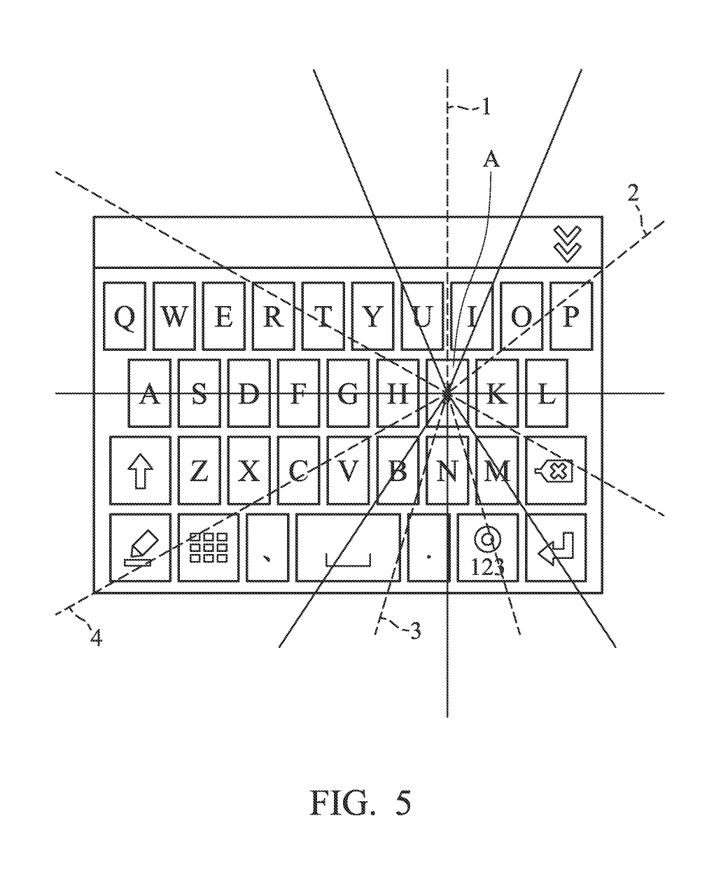

The error correction unit 123 is coupled to the obtaining unit 122, and is used for performing input error correction. Specifically, the error correction unit 123 determines at least one candidate target key to replace the input key according to the input key and the slide angle of the sliding input, and then determines the target key for replacing the input key according to the slide direction and at least one candidate target key. FIG. 5 illustrates the boundaries between the areas of the adjacent keys based on a Qwerty keyboard according to an embodiment of the present invention. As shown in FIG. 5, given that the key J is the input key, set the center of the key J as a starting point, connect the starting point to the other centers of keys K, I, U, H, B, N and M which are near and around the key J to establish 7 rays (solid lines in FIG. 5), and then get 7 angular bisectors of every two adjacent rays (dash line in FIG. 5), where each angle between two adjacent angular bisectors corresponds to a respective adjacent key. In this manner, the error correction unit 123 defines the adjacent keys and their corresponding angles as shown in FIG. 5. For example, the angle between angular bisectors 1 and 2 (roughly, 30°˜90°) corresponds to the key I, and the angle between angular bisectors 3 and 4 (roughly, 25˜60°) corresponds to the key B. In one embodiment, when the sliding input has a slide angle of 45° after entering the input key J, the error correction unit 123 can determine candidate target keys (i.e., keys I and B) to replace the input key J according to the input key J and the slide angle 45°. Then, the error correction unit 123 can determine the final target key I for replacing the input key J from the candidate keys I and B according to the slide direction of the sliding input (e.g., from key J to key I). Note that this embodiment is merely for illustration, and the present invention should not be limited thereto. In another embodiment, connect the center of the key J, as the starting point, to the centers of the adjacent keys K, N and H to form 3 rays, and to the corner of the adjacent keys I, U, B and M to form another 4 rays. In yet another embodiment, other rays (other than the angular bisectors) can be used as the boundaries between the areas of the adjacent keys. Additionally, in some embodiments, the slide direction of the sliding input can be used to indicate its corresponding target key according to the user habits. For example, in FIG. 5, the slide direction from key J to key I indicates that the target key for replacing the input key J is the key I. Various techniques can be modified by those skilled in the art according to the spirit of the present invention, and these techniques are all within the scope of the present invention.

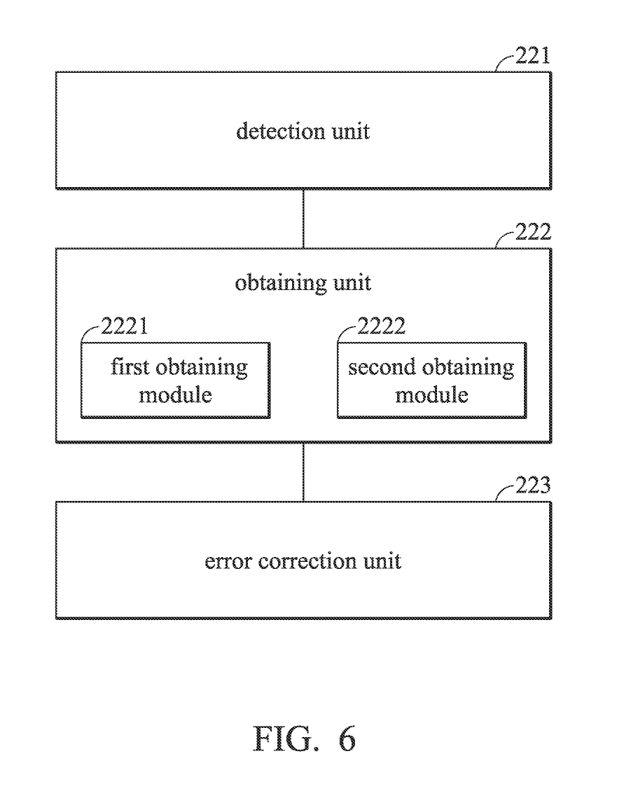

In some embodiments, users may be prone to produce some sliding inputs with certain slide directions, for example, from the bottom left to the upper right. FIG. 6 is a schematic diagram of an input error-correction apparatus according to an embodiment of the present invention. In the embodiment shown in FIG. 6, the processor 12 comprises a detection unit 221, an obtaining unit 222, and an error correction unit 223. The detection unit 221 is similar to the detection unit 121 shown in FIG. 2, further description is omitted here for brevity. The obtaining unit 222 is coupled to the detection unit 221, and is used to obtain the slide angle from the sliding input, and the input position of the input key. The manner by which the obtaining unit 222 determines the slide angle is similar to that of the obtaining unit 122 as shown in FIG. 2. In one embodiment, the obtaining unit 222 comprises a first obtaining module 2221, which is used for obtaining the slide angle in the manner of FIG. 3, further description is omitted here for brevity. In another embodiment, the obtaining unit 222 comprises a second obtaining module 2222, which is used for obtaining the slide angle in the manner of FIG. 4, further description is omitted here for brevity. In one embodiment, the first obtaining module 2221 and the second obtaining module 2222 are different modules. In another embodiment, the first obtaining module 2221 and the second obtaining module 2222 are integrated into a common module. Note that the techniques for obtaining the slide angle is merely for illustration, and the present invention should not be limited thereto. Those skilled in the art can properly modify these techniques according to the spirit of the present invention, and the modified techniques are within the scope of the present invention. The obtaining unit 222 can be further used to obtain the input position of the input key.

The error correction unit 223 is coupled to the obtaining unit 222 and is used to determine the target key for replacing the input key according to the input position of the input key and the slide angle of the sliding input. The error correction unit 223 determines at least one candidate target key to replace the input key according to the input position and the slide angle. As shown in FIG. 5, in one embodiment, when the sliding input has a slide angle of 45° after entering the input key J, the error correction unit 223, according to the input key J and the slide angle of 45°, can determine that the candidate target keys for replacing the key J are keys I and B. The point A in FIG. 5 is the input position of the input key J. The error correction unit 223 further calculates the distances between the input position A and the candidate target keys I and B. In one embodiment, the distance between the input position A and the key I/B means the “shortest” distance between the input position A and the boundary of the key I/B. In another embodiment, the distance between the input position A and the key I/B means the distance between the input position A and the center of the key I/B. Note that the techniques for obtaining the distance is merely for illustration, and the present invention should not be limited thereto. Those skilled in the art can properly modify these techniques according to the spirit of the present invention, and the modified techniques are within the scope of the present invention. For input error correction, the error correction unit 223 can determine that the candidate target key which has the shortest distance to the input position is the target key.

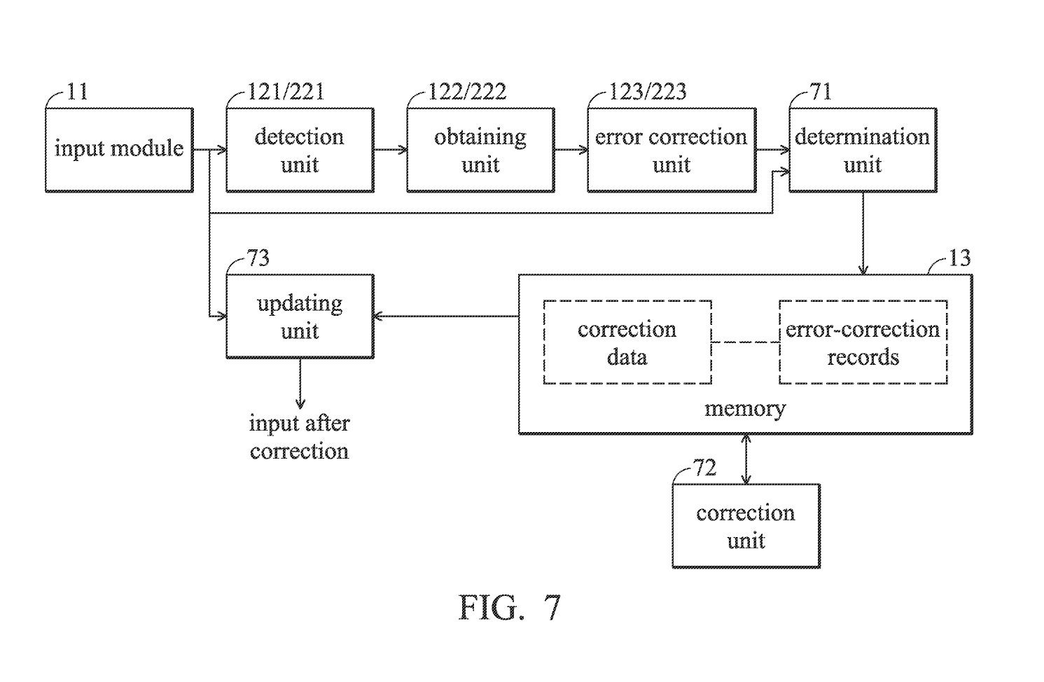

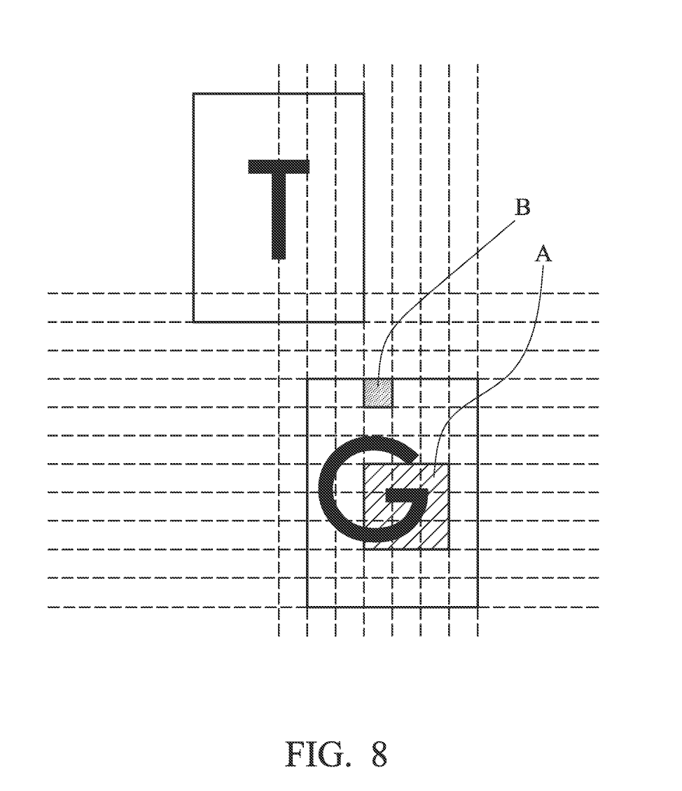

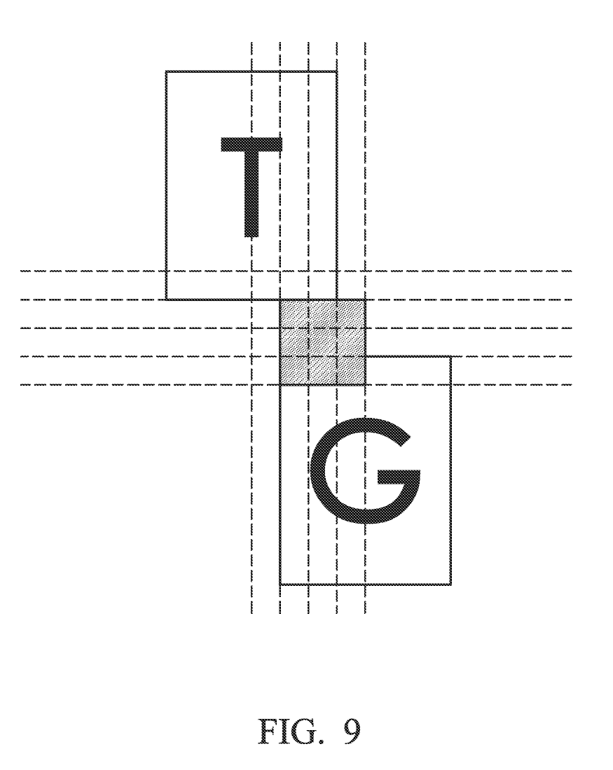

FIG. 7 is a schematic diagram of the input error-correction apparatus according to another embodiment of the present invention. In order to perform the input error correction more rapidly, the processor of the present invention, as shown in FIG. 7, further comprises a determination unit 71, an updating unit 72, and a correction unit 73. The determination unit 71 is coupled to the input module 11 and the error correction unit (for example, the error correction unit 123 or the error correction unit 223) for determining whether the current sliding input is an error-correction record. Generally, a user should click a key in a substantial fixed area. If the input position is away from this fixed area and closer to the target key determined by the error correction unit, it can be determined that the sliding input is an error-correction record. As shown in FIG. 8, FIG. 8 is a schematic diagram showing an input key which is divided into several small areas (square or rectangle) according to an embodiment of the present invention. Area A is the fixed area of the key G where the most, e.g. 90%, chance of the user' clicking occurs. Area B is the area of the input position, which has a significant deviation from the area B and is closer to the target key T. Therefore, it is determined that the sliding input is an error-correction record. Further, to determine the error-correction record more precisely, the determination unit 71 further determines whether the user's input constitutes a word or words with meaning. If the original input does not constitute a word but the corrected input does, it is determined that the current sliding input is an error-correction record. As shown in FIG. 8, the user clicks the area B to input the key G, but it will be finally revised to key T by a sliding input. Since the area B is away from the area A but is closer to the key T, and the original word, for example, “Nogification” is meaningless but the revised “Notification” is not, it can be determined than the sliding input is an error-correction record. Note that the location, size and the shape of the areas A and B in FIG. 8 are merely for illustration, and the present invention should not be limited thereto. Those skilled in the art can properly modify the location, size and the shape of these areas according to the spirit of the present invention, and all such modifications are within the scope of the present invention.

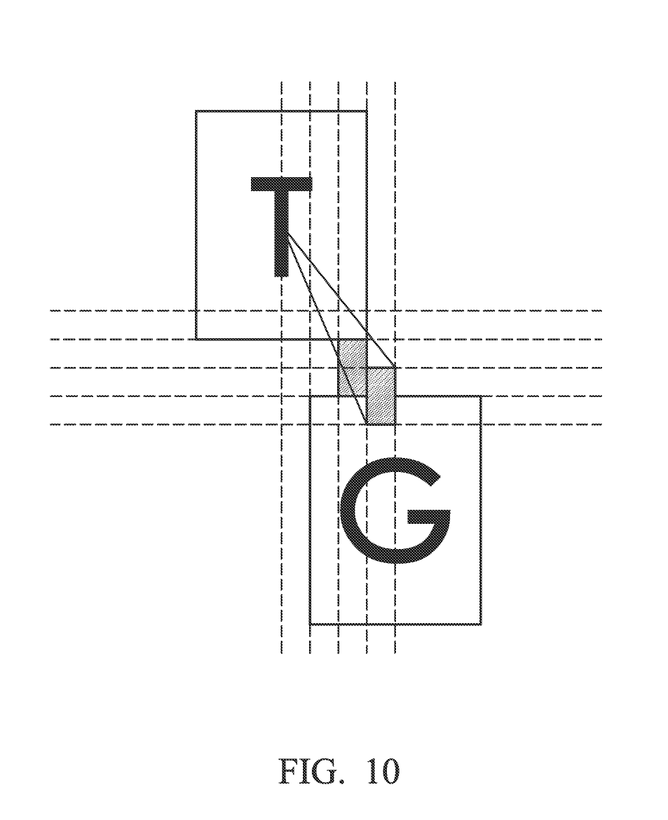

If the determination unit 71 determines that the current sliding input is an error-correction record, the determination unit 71 stores the error-correction record into the memory 13. The updating unit 72 is configured to update the correction data when the stored error-correction records reach the predetermined correction criteria. For example, in the embodiment of FIG. 8, a situation where the user rarely clicks area A to input the key G (e.g. lower than 20%) but there are numerous error-correction records (e.g. more than 5 times) occurring at area B can be regarded as a correction criteria. In this situation, the correction data should be updated to correct the area B to be an area for inputting key T. For improving correction efficiency, the area B as well as the areas which are closer to the key T can be seen as the areas for key T, as shown in FIG. 9 and FIG. 10. FIG. 9 shows the divided correction areas according to an embodiment of the present invention. FIG. 10 shows the divided correction areas according to another embodiment of the present invention. The shadow areas in FIG. 9 and FIG. 10 are sorted into the areas for key T, where the shadow areas in FIG. 9 and FIG. 10 are close to the key T, and are rarely used to input key G (e.g. with the chance of that being less than 20%). Note that the present invention should not be limited to the previous embodiments, and the number of error-correction records and the change of clicking a wrong area can be set by users according to actual situations. Which areas in FIGS. 9 and 10 should be sorted into the areas for the key T can be determined according to design needs and actual situations. Those skilled in the art can properly modify the size and the shape of these areas according to the spirit described in FIGS. 9 and 10, and all such modifications are within the scope of the present invention.

The correction unit 73 is used for input error correction. When entering the input key again, the correction unit 73 uses the updated correction data to set the target key (which is used for replacing the input key) as a correction item that corresponds to the correction data.

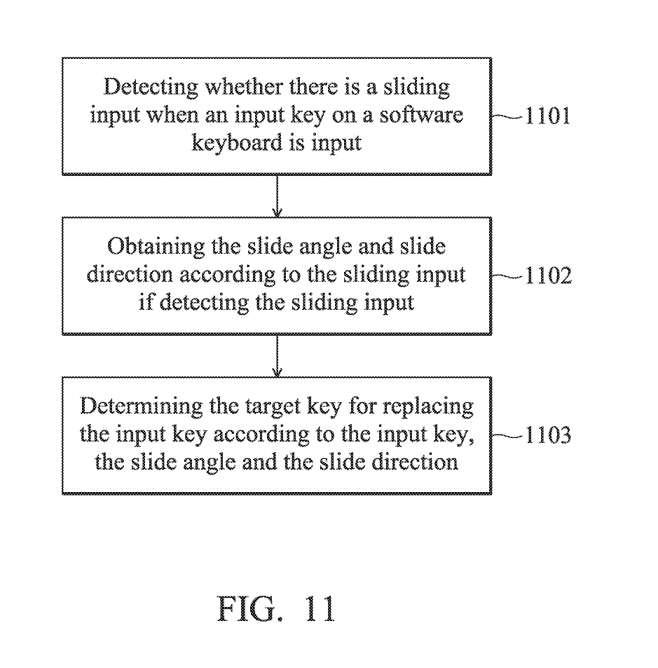

FIG. 11 is a flow chart of the input error-correction method according to an embodiment of the present invention. The input error-correction method can be utilized by the processor 12 of FIG. 1 and the input error-correction apparatus of FIG. 2. As shown in FIG. 11, in step 1101, it is detected whether there is a sliding input when an input key on a software keyboard is input. If detecting the sliding input, in step 1102, the slide angle and slide direction is obtained according to the sliding input. For example, in some embodiments, the method for obtaining the slide angle is the same as that in FIG. 3 or FIG. 4, and will not be discussed here. In step 1103, for input error correction, the target key for replacing the input key is determined according to the input key, the slide angle and the slide direction. For example, in some embodiments, the manner for determining the target key is described in FIG. 5, and will not be discussed further here.

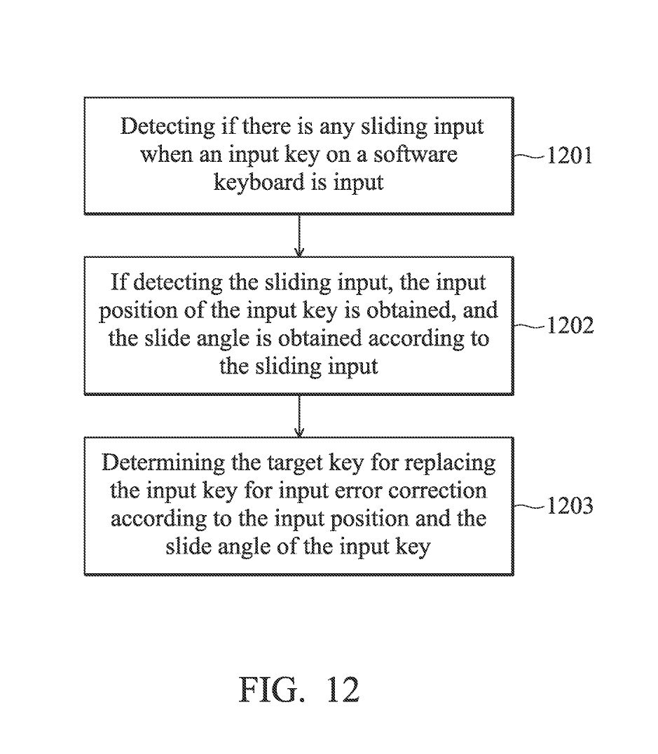

FIG. 12 is a flow chart of the input error-correction method according to an embodiment of the present invention. The input error-correction method can be utilized by the processor 12 in FIG. 1 or input error-correction apparatus in FIG. 6. As shown in FIG. 12, in step 1201, when an input key on a software keyboard is input, it is detected if there is any sliding input. In step 1202, if detecting the sliding input, the input position of the input key is obtained, and the slide angle is obtained according to the sliding input. For example, in some embodiments, the method for obtaining the slide angle is the same as that in FIGS. 3 and 4, and will not be discussed further here. In step 1203, for input error correction, the target key for replacing the input key is determined according to the input position of the input key and the slide angle. For example, in some embodiments, the method for determining the target key is the same as that in FIGS. 8-10, and will not be discussed further here.

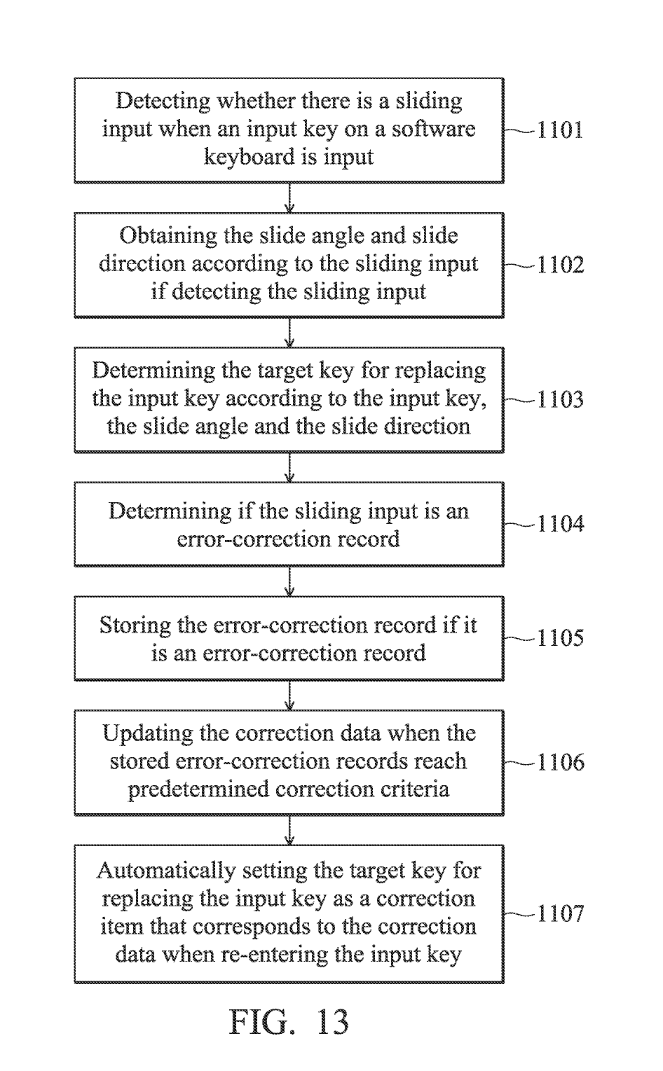

FIG. 13 is a flow chart of the input error-correction method according to an embodiment of the present invention. The input error-correction method can be utilized by the processor 12 in FIG. 1 or the input error-correction apparatus in FIG. 7. As shown in FIG. 13, after determining the target key for replacing the input key for input error correction (the method is shown in FIGS. 11 and 12), in step 1104, the input error-correction method determines if the sliding input is an error-correction record. In some embodiments, the method for determining the error-correction record is shown in FIG. 8, and will not be discussed further. In step 1105, if it is an error-correction record, the error-correction record is stored. In step 1106, when the stored error-correction records reach predetermined correction criteria, the correction data is updated. In step 1107, for input error correction, when re-entering the input key, the target key for replacing the input key is automatically set as a correction item that corresponds to the correction data. By using the input error-correction apparatus and the input error-correction method of the present invention, the input errors can be efficiently corrected and the input success rate can be greatly improved for various types of software-keyboard input module.

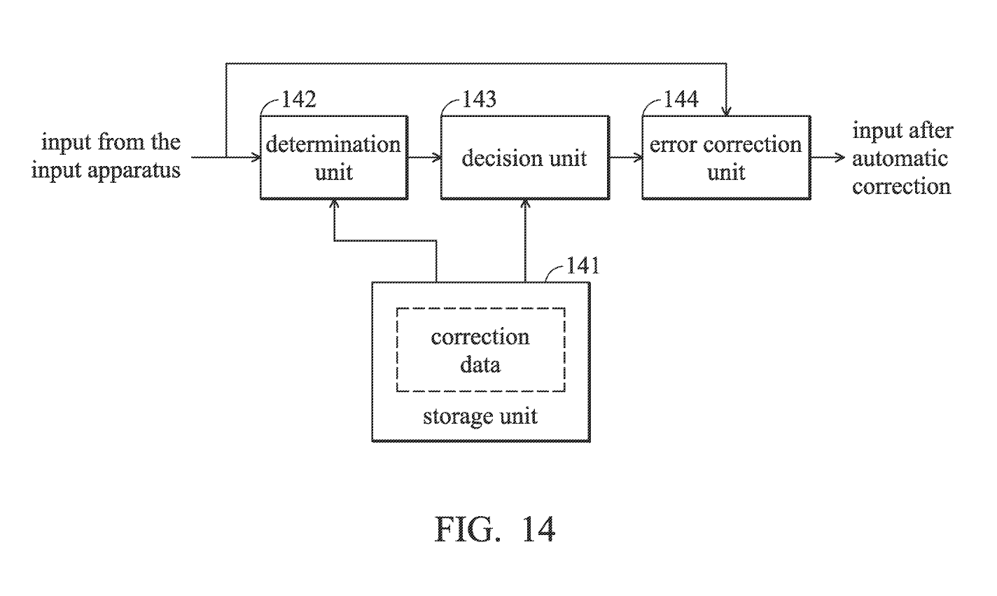

The processor 12 and the memory 13 in FIG. 1 can be used as the automatic error-correction apparatus. FIG. 14 is a schematic diagram of the automatic error-correction apparatus according to an embodiment of the present invention. In one embodiment of the present invention, as shown in FIG. 14, the automatic error-correction apparatus comprises a storage unit 141, a determination unit 142, a decision unit 143, and an error correction unit 144. The automatic error-correction apparatus receives inputs from the input module, such as the input of the input keys of a software keyboard or a physical keyboard. For example, in some embodiments, users could enter the input by clicking, sliding or the like. The storage unit 141 is used to store the correction database containing the correction data. The determination unit 142 is used to determine, after an input key on the input module is input, if the correction procedure is required. The decision unit 143 is used to obtain the correction item corresponding to the input key according to correction data which corresponds to the input key stored in the correction database when the correction procedure is required. The error correction unit 144 is used to automatically replace the input key with the correction item which corresponds to the input key, for error correction. In one embodiment of the present invention, when the correction data which corresponds to the input key is not stored in the correction database, it is determined that no correction procedure is required. And, when the correction data which corresponds to the input key has been stored in the correction database, it is determined that the correction procedure is required. As shown in FIG. 8, the area B, which originally indicates key G but is corrected to indicate key T, is the correction data which corresponds to the key G. When the user clicks the area B for inputting key G, the determination unit 142 determines that the correction procedure is required. As shown in FIGS. 9 and 10, the shadow area, which originally indicates key G but is corrected to indicate key T, is the correction data which correspond to the key G. When the user clicks the shadow area for inputting key G, the determination unit 142 determines that the correction procedure is required. In this embodiment, according to the correction data corresponding to the key G stored in the correction database, the decision unit 143 determines that the correction item which corresponds to the ikey G is the key T. Therefore, the error correction unit 144 automatically replaces the “G” input from the input module with “T” , and completes the automatic error correction procedure.

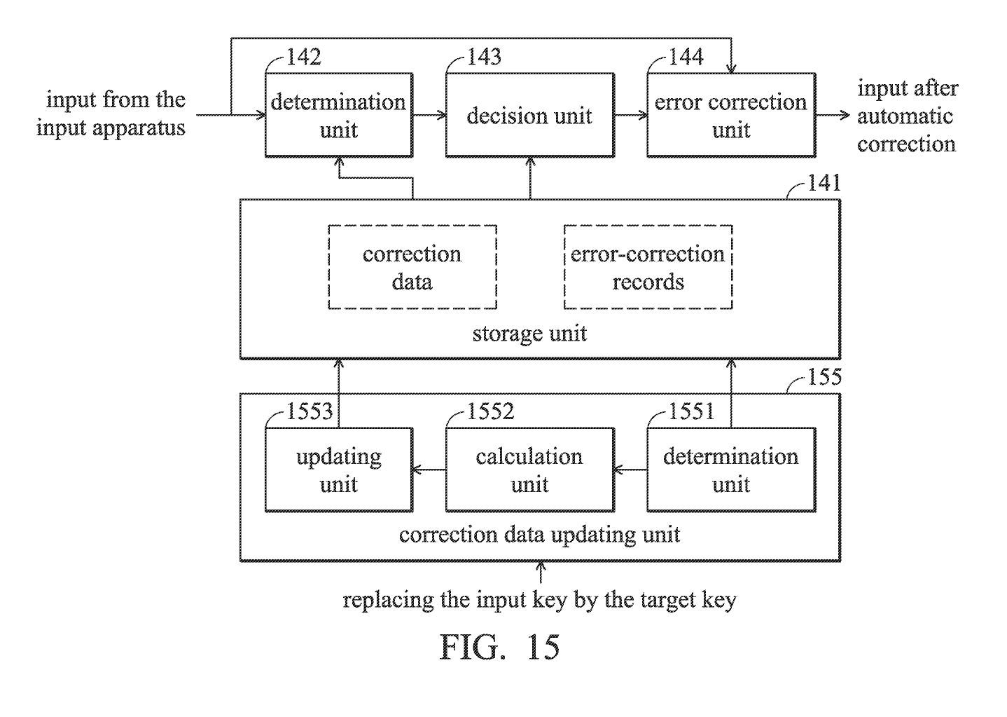

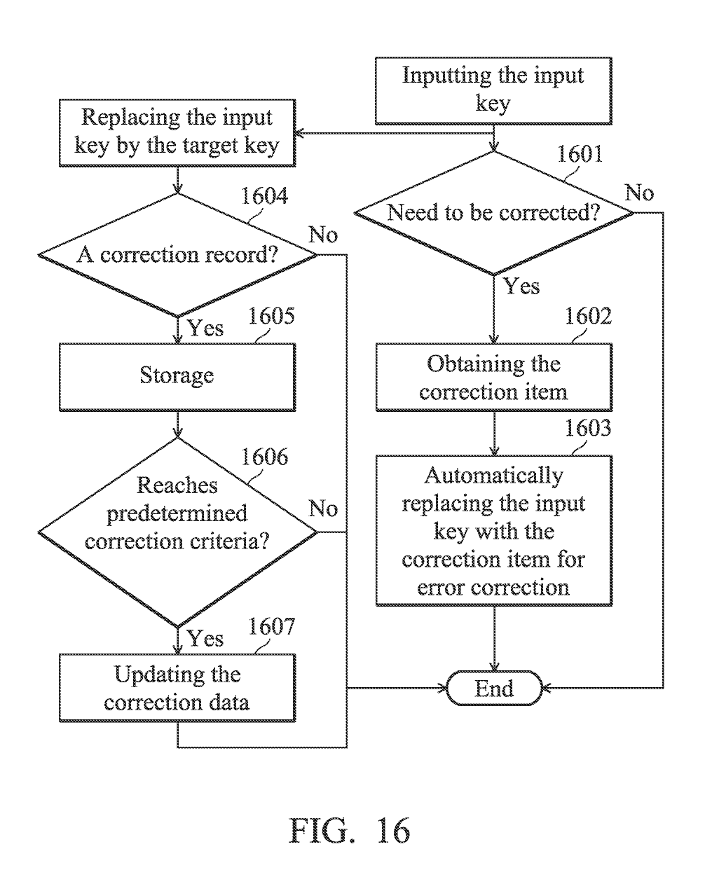

In some embodiments of the present invention, as shown in FIG. 2 and FIG. 6, after an input key on a software keyboard is input, it is detected whether there is a sliding input; and then, the target key for replacing the input key for input error correction can be determined according to the input key and the sliding input. In one embodiment of the present invention, after an input key is replaced by a target key, it is inspected to determine whether the target key is an error-correction record. If it is an error-correction record, the error-correction record will be stored in the storage unit, and when the stored error-correction records reach the predetermined correction criteria, the correction data which corresponds to the input key will be updated. FIG. 15 is a schematic diagram of the automatic error-correction apparatus according to an embodiment of the present invention. In addition to the automatic error-correction apparatus in FIG. 14, the automatic error-correction apparatus in FIG. 15 further comprises a correction data updating unit 155, and the correction data updating unit 155 comprises a determination unit 1551 for detecting if the target key is an error-correction record when the input key is replaced with the target key. Please refer to FIG. 8, where the keyboard is divided into numerous rectangle (or square) areas. The area A is a substantial fixed region that the user inputs the key G (e.g. with a probability of more than 80%), and the shadow area B is the current input position. Since area B is obviously deviated from the area A and close to the target key T, the determination unit 1551 determines that the target key T is the error-correction record. To determine the error-correction record more precisely, the determination unit 1551 further determines whether the keys input by the user form a word or words with meaning. If the original input keys do not form a word (or words) with meaning but do after being corrected, the target keys which replace the input keys are determined to be the error-correction records. As shown in FIG. 8, the user first clicks area B and inputs “G”, but the “G” is then replaced by “T” according to the sliding input. Since the area B deviates from the area A and close to the key T, and the word originally formed, for example, “Nogification” is meaningless but the corrected word, for example, “Notification” , has meaning, thus the target key T can be determined as the error-correction record. Note that the location, shape and size of the areas A and B in FIG. 8 are merely for illustration, and the present invention should not be limited thereto. Those skilled in the art can properly modify the location, shape and size of the areas according to the spirit of the present invention, and the modified designs are within the scope of the present invention. After determining that the target key is the error-correction record, the determination unit 1551 stores the error-correction record in the storage unit 141.

The correction data updating unit 155 comprises a calculation unit 1552, which is used to count the number of error-correction records determined by the determination unit 1551. The correction data updating unit 155 further comprises an updating unit 1553, which is used to update the correction data corresponding to the input key when the number counted by the calculation unit 1552 reaches a predetermined value. In an embodiment of the present invention, as shown in FIG. 8, when there are numerous times (for example, more than 5 times) that the G key is replaced with the target key T (i.e., that the target key T is determined to be an error-correction record), the correction data which corresponds to the input key should be updated. For example, when the area B of the input key G has been adjusted to correspond to the input key T several times (for example, 5 times), the correction data which corresponds to the input key G should be updated to correspond to inputting of key T. In order to determine more precisely whether the correction data should be updated, the calculation unit 1552, for example, calculates the probability that the area B is for inputting key G, and, when the probability is lower than, for example, 20%, determines that the correction data corresponding to the input key should be updated according the probability combined with the number of error-correction records. In this manner, the predetermined correction criteria can be determined according to the predetermined value of the error-correction records, or the predetermined value combined with the probability (for example, lower than 20%) that an area (for example, the area B) is for inputting the current input key (for example, the input key G). When re-entering the input key G, and if the determination unit 142 determines that the input key should be replaced, the decision unit 143 obtain the updated correction item (i.e., the target key T) which corresponds to the input key according to the updated correction data, and the error correction unit 144 automatically replaces the input key G with the updated correction item (i.e., the target key T) and completes the automatic error correction procedure. More precisely, the determination unit 1551 further determines whether the target key helps to form a word or words with meaning. If yes, the target key is determined to be the error-correction record. Note that the number of error-correction records and the probability that an area is for inputting a certain key can be set according to design requirements and a user's actual use, and the present invention should not be limited to the said embodiments.

FIG. 16 is a flow chart of the automatic error-correction method according to an embodiment of the present invention. The automatic error-correction method can be utilized by the automatic error-correction apparatus in FIGS. 14 and 15. As shown in FIG. 16, in step 1601, when entering an input key on the input device, it is determined whether the input key needs to be corrected. If yes, the correction item corresponding to the input key is obtained in step 1602 according to correction data corresponding to the input key stored in a correction database. In step 1603, for error correction, the input key is automatically replaced with the correction item which corresponds to the input key. Specifically, in step 1601, when the correction data which corresponds to the input key is not stored in the correction database, it is determined that the correction procedure is not required; and when the correction data which corresponds to the input key is stored in the correction database, it is determined that the correction procedure is required. In step 1604, when the input key of the input module is replaced with the target key, it is determined whether the target key is an error-correction record. Specifically, in step 1604, when the input position of the input key deviates from a fixed area and close to the target key, it is determined that the target key is the error-correction record. Further, if the replacement of the target key helps to form a word with meaning, it is determined that the target key is the error-correction record. In step 1605, if it is the error-correction record, the error-correction record is stored. In step 1606, it is determined whether the stored error-correction records reach to predetermined correction criteria. Specifically, in step 1606, the number of error-correction records is counted, and when the number reaches a predetermined value, it is determined that the predetermined correction criteria is met. In step 1607, when the predetermined correction criteria is met, the correction data which corresponds to the input key is updated. To be more precise, in step 1606, the probability that an area is for inputting the current input key is calculated and is seen as the predetermined correction criteria. Detailed embodiments have been discussed in the description of the calculation unit 1552, and, for simplicity, they will not be discussed again.

The automatic error-correction apparatus and the automatic error-correction method provided by the present invention can perform the automatic error correction procedure for input module so as to simplify the input correction operation for users and improve the correct input rate.

Those skilled in the art can understand that the logic blocks, units and steps described in the embodiments of the present invention can be implemented by electronic hardware, computer software, or a combination of both. The functions of the parts, units and steps of the present invention have been described in detail so that one can easily implement them in using software or hardware. How to implement the function depends on the use and design of the whole system. Those skilled in the art can implement these functions in various ways, and the various techniques are not beyond the present invention.

The logic blocks and units described in the previous embodiments of the present invention can be implemented by using processors, digital signal processors, application specific integrated circuits (ASICs), field programmable field arrays (FPGAs) other programmable logic devices, discrete gates, transistor logics, or a combination thereof. A universal processor can be a microprocessor, or any conventional processor, controller, microcontroller, or state machine. The processor can be implemented by using the combination of computer devices such as digital signal processors, microprocessors, multiple micro processors, and the like.

The steps of the methods described in the embodiments of the present invention can be embedded into a hardware module, a software module or a combination of both which is operated by a processor. The software module can be stored into RAM memories, flash memories, ROM memories, EPROM memories, EEPROM memories, registers, hard disks, removable disks, CD-ROMs or other storage media. For example, the storage media can be coupled to the processor so that the processor can read data from and write data into the storage media. Optionally, the storage media can be integrated into the processor. The processor and the storage media can be configured in ASICs, and the ASICs can be disposed in a user terminal. Optionally, the processor and the storage media can be disposed in different parts of the user terminal.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An input error-correction method for a software keyboard, the method comprising:
when entering an input key on the software keyboard, detecting if there is a sliding input;
if there is a sliding input, obtaining a slide angle and a slide direction from the sliding input; and
determining a target key to replace the input key according to the input key, the slide angle, and the slide direction for input error correction.

2. The input error-correction method as claimed in claim 1, wherein the step of obtaining the slide angle comprising:
obtaining the slide angle from a straight line defined by a starting point and an end point of the sliding input.

3. The input error-correction method as claimed in claim 1, wherein the step of obtaining the slide angle comprising:
obtaining the slide angle from an angular bisector of a most inclined ray and a least inclined ray, both selected from a series of rays defined by a starting point and one of a plurality of points on a sliding locus of the sliding input.

4. The input error-correction method as claimed in claim 1, wherein the step of determining the target key to replace the input key further comprising:
determining at least one candidate target key for replacing the input key according to the input key and the slide angle;
determining the target key for replacing the input key according to the slide direction and the at least one candidate target key for input error correction.

5. The input error-correction method as claimed in claim 4, wherein the step of determining at least one candidate target key further comprising:
linking the input key to a plurality of adjacent keys, which are adjacent to the input key, to form a plurality of rays; obtaining a plurality of angular bisectors of every two adjacent rays; corresponding each angle between every two adjacent angular bisectors to a respective one of the adjacent keys;
selecting at least two of the adjacent keys as the candidate target keys according to the slide angle.

6. The input error-correction method as claimed in claim 5, wherein the step of linking the input key to a plurality of adjacent keys to form a plurality of rays further comprising:
linking the center of the input key to the centers of the plurality of adjacent keys to form a plurality of rays.

7. The input error-correction method as claimed in claim 1, further comprising:
determining if the sliding input is an error-correction record;
storing the error-correction record if the sliding input is an error-correction record;
updating correction data when the stored error-correction record meets predetermined correction criteria; and
when re-entering the input key, automatically setting the target key as a correction item, which corresponds to the correction data, for input error correction.

8. An input error-correction apparatus for a software keyboard, the apparatus comprising:
a detection unit, for detecting if there is a sliding input when an input key on the software keyboard is entered;
an obtaining unit, for obtaining a slide angle and a slide direction from the sliding input; and
an error correction unit, for determining a target key to replace the input key according to the input key, the slide angle, and the slide direction for input error correction.

9. The input error-correction apparatus as claimed in claim 8, wherein the obtaining unit comprising:
a first obtaining module, for obtaining the slide angle from a straight line defined by a starting point and an end point of the sliding input.

10. The input error-correction apparatus as claimed in claim 8, wherein the obtaining unit comprises
a second obtaining module, for obtaining the slide angle from an angular bisector of a most inclined ray and a least inclined ray, both selected from a series of rays defined by a starting point and one of a plurality of points on a sliding locus of the sliding input.

11. The input error-correction apparatus as claimed in claim 8, wherein the error correction unit determines at least one candidate target key for replacing the input key according to the input key and the slide angle, and determines the target key for replacing the input key according to the slide direction and the at least one candidate target key for input error correction.

12. The input error-correction apparatus as claimed in claim 11, wherein the error correction unit links the input key to a plurality of adjacent keys, which are adjacent to the input key, to form a plurality of rays; obtains a plurality of angular bisectors of every two adjacent rays; corresponds each angle between every two adjacent angular bisectors to a respective one of the adjacent keys; and, selects at least two of the adjacent keys as the at least one candidate target key according to the slide angle.

13. The input error-correction apparatus as claimed in claim 12, wherein the error correction unit further links the center of the input key to the centers of the plurality of adjacent keys to form a plurality of rays.

14. The input error-correction apparatus as claimed in claim 8, further comprising:
a determination unit, for determining if the sliding input is an error-correction record; and storing the error-correction record in a memory if the sliding input is an error-correction record;
an updating unit, for updating correction data when the stored error-correction record meets predetermined correction criteria; and
a correction unit, for, when re-entering the input key, automatically setting the target key as a correction item, which corresponds to the correction data, for input error correction.

15. An input error-correction method for a software keyboard, the method comprising:
when entering an input key on the software keyboard, detecting if there is a sliding input;
if there is a sliding input, obtaining an input position of the input key and a slide angle from the sliding input; and
determining a target key to replace the input key according to the input position and the slide angle for input error correction.

16. The input error-correction method as claimed in claim 15, wherein the step of obtaining the slide angle comprising:
obtaining the slide angle from a straight line defined by a starting point and an end point of the sliding input.

17. The input error-correction method as claimed in claim 15, wherein the step of obtaining the slide angle comprising:
obtaining the slide angle from an angular bisector of a most inclined ray and a least inclined ray, both selected from a series of rays defined by a starting point and one of a plurality of points on a sliding locus of the sliding input.

18. The input error-correction method as claimed in claim 15, wherein the step of determining the target key to replace the input key further comprising:
determining at least one candidate target key for replacing the input key according to the input position and the slide angle; and
selecting a candidate target key which is closest to the input position as the target key according to the input position and the at least one candidate target key, for input error correction.

19. The input error-correction method as claimed in claim 15, further comprising:
determining if the sliding input is an error-correction record;
storing the error-correction record if the sliding input is an error-correction record;
updating correction data when the stored error-correction record meets predetermined correction criteria; and
when re-entering the input key, automatically setting the target key as the correction data for input error correction.

20. An input error-correction apparatus for a software keyboard, the apparatus comprising:
a detection unit for detecting if there is a sliding input when an input key on the software keyboard is entered;
an obtaining unit for obtaining an input position of the input key and a slide angle from the sliding input; and
an error correction unit for determining a target key to replace the input key according to the input position and the slide angle for input error correction.

21. The input error-correction apparatus as claimed in claim 20, wherein the obtaining unit comprising:
a first obtaining module, for obtaining the slide angle from a straight line defined by a starting point and an end point of the sliding input.

22. The input error-correction apparatus as claimed in claim 20, wherein the obtaining unit comprising:
a second obtaining module, for obtaining the slide angle from an angular bisector of a most inclined ray and a least inclined ray, both selected from a series of rays defined by a starting point and one of a plurality of points on a sliding locus of the sliding input.

23. The input error-correction apparatus as claimed in claim 20, wherein the error correction unit determines at least one candidate target key for replacing the input key , according to the input position and the slide angle; and selecting a candidate target key which is closest to the input position as the target key according to the input position and the at least one candidate target key, for input error correction.

24. The input error-correction apparatus as claimed in claim 20, further comprising:
a determination unit for determining if the sliding input is an error-correction record; and storing the error-correction record in a memory if the sliding input is an error-correction record;
an updating unit for updating correction data when the stored error-correction record meets predetermined correction criteria; and
a correction unit, for, when re-entering the input key, automatically setting the target key as the correction data for input error correction.

25. An automatic error-correction method for an input device, the method comprising:
when entering an input key of the input device, determining if the input key needs to be corrected;
if the input key needs to be corrected, obtaining a correction item corresponding to the input key according to correction data corresponding to the input key stored in a correction database; and
automatically replacing the input key with the correction item corresponding to the input key for error correction.

26. The automatic error-correction method as claimed in claim 25, wherein the step of determining if the input key of the input device needs to be corrected comprising:
when there is no correction data corresponding to the input key in the correction database, determining that the input key does not need to be corrected;
when there is correction data corresponding to the input key in the correction database, determining that the input key needs to be corrected.

27. The automatic error-correction method as claimed in claim 25, further comprising:
when the input key of the input device is replaced by a target key, determining if the target key is an error-correction record;
if the target key is the error-correction record, storing the error-correction record;
if the stored error-correction records reach to predetermined correction criteria, updating the correction data corresponding to the input key.

28. The automatic error-correction method as claimed in claim 27, wherein the step of determining if the target key is an error-correction record comprising:
when an input position of the input key is away from a fixed area and the input position is near the target key, determining that the target key is the error-correction record.

29. The automatic error-correction method as claimed in claim 28, further comprising:
if a word with meaning can be produced after replacing the input key with the target key, determining the target key is the error-correction record.

30. The automatic error-correction method as claimed in claim 27, wherein the step of updating the correction data of the input key comprising:
counting the number of error-correction records, and updating the correction data corresponding to the input key when the number reaches a predetermined value.

31. The automatic error-correction method as claimed in claim 27 further comprising:
when re-entering the input key, if the input key needs to be corrected, obtaining an updated correction item corresponding to the input key according to the updated correction data, and automatically replacing the input key with the updated correction item corresponding to the input key, for error correction, wherein the updated correction item corresponding to the updated input key is the target key.

32. An automatic error-correction apparatus for an input device, the apparatus comprising:
a storage unit for storing a correction database containing correction data;
a determination unit for determining, when an input key of the input device is entered, if the input key needs to be corrected;
a decision unit for obtaining a correction item corresponding to the input key according to the correction data corresponding to the input key stored in the correction database; and
an error correction unit, for automatically replacing the input key with the correction item corresponding to the input key for error correction.

33. The automatic error-correction apparatus as claimed in claim 32, wherein the determination unit further determines that the input key does not need to be corrected when there is no correction data corresponding to the input key in the correction database; and determines that the input key needs to be corrected when there is correction data corresponding to the input key in the correction database.

34. The automatic error-correction apparatus as claimed in claim 32, wherein the storage unit further stores error-correction records; and the automatic error-correction apparatus further comprising:
a correction data updating unit for determining if the target key is an error-correction record when the input key of the input device is replaced by a target key; if the target key is an error-correction record, the error-correction record is stored in the storage unit; and if the stored error-correction records reach to predetermined correction criteria, the correction data corresponding to the input key is updated.

35. The automatic error-correction apparatus as claimed in claim 34, wherein,
determining that the target key is the error-correction record, when an input position of the input key is away from a fixed area and the input position is near the target key.

36. The automatic error-correction apparatus as claimed in claim 35, wherein,
determining that the target key is the error-correction record if a word with meaning can be produced after replacing the input key with the target key.

37. The automatic error-correction apparatus as claimed in claim 34, wherein,
the correction data updating unit counts the number of error-correction records, and updates the correction data corresponding to the input key when the number reaches a predetermined value.

38. The automatic error-correction apparatus as claimed in claim 34, wherein,
when the input key is re-entered, if the determination unit determines that the input key needs to be corrected, the decision unit obtains an updated correction item corresponding to the input key according to the updated correction data, and the error correction unit automatically replaces the input key with the updated correction item corresponding to the input key, for error correction, wherein the updated correction item corresponding to the updated input key is the target key.

39. A mobile terminal, comprising an input error-correction apparatuses as claimed in claim 8, for performing error correction for the input of a software keyboard of the mobile terminal.

40. A mobile terminal, comprising an input error-correction apparatuses as claimed in claim 20, for performing error correction for the input of a software keyboard of the mobile terminal.

41. A mobile terminal, comprising an automatic error-correction apparatuses as claimed in claim 32, for performing automatic error correction on the input to the input device of the mobile terminal.
